(19) United States
(12) Patent Application Publication
(10) Pub. No.: US 2015/0313079 A1
(43) Pub. Date: Nov. 5, 2015

(54) Grass Trimmer

(71) Applicant: Wen Chang Wang, Tainan City (TW)

(72) Inventor: Wen Chang Wang, Tainan City (TW)

(21) Appl. No.: 14/797,330

(22) Filed: Jul. 13, 2015

Related U.S. Application Data
(62) Division of application No. 13/547,103, filed on Jul. 12, 2012.

(51) Int. Cl. A01D 34/90; A01D 34/82

(52) U.S. Cl. CPC A01D 34/90; A01D 34/824

(57) ABSTRACT

A shoulder hanging type and backpack type grass trimmer handle includes a joint installed at the middle of a main body for positioning a handle. The joint includes a lower casing; a fixed base having an upper casing at a lower end of the fixed base and corresponding to the lower casing for fixing the main body, and the upper end has a containing slot for axially connecting the handle; and a positioning element for unfolding the handle to transversally position at the fixed base, folding the handle to longitudinally attach to and position at both sides of the main body, to achieve the effects of folding and unfolding the device easily, reducing the volume of the device, and facilitating the storage and transportation of the device.

### BACKGROUND OF THE INVENTION

1. Field of the Invention

The present invention relates to a shoulder hanging type and backpack type grass trimmer folding device and, more particularly, to a device capable of being folded and unfolded easily, reducing volume, and facilitating storage and transportation.

2. Description of the Related Art

With reference to FIG. 1 for a conventional shoulder hanging type and backpack type grass trimmer, the grass trimmer comprises a cutter 11 installed at a front end of the grass trimmer, an engine 12 and a back strap (not shown in the figure) installed at a back end of the grass trimmer, and a control handle 13 installed at the middle of the grass trimmer and extended sideway and upward to fix with a main body 10, to facilitate both hands to grip and control the grass trimmer.

The conventional shoulder handing type and backpack type grass trimmer is a long machine, and the handle 13 is fixed, so that the use of the grass trimmer has the following drawbacks that require improvements.
1. The handle 13 is fixed to the main body 10 and cannot be folded, and thus incurring a large packaging volume, a high transportation cost, and a risk of tripping users while the users carry or move the grass trimmer without packaging.
2. If the handle 13 is removed to avoid the aforementioned drawback, the users have to reinstall the handle 13 for its use, and thus causing inconvenience to the users, and a risk of falling out if the handle 13 is not installed securely.

### SUMMARY OF THE INVENTION

Therefore, it is a primary objective of the present invention to overcome the aforementioned drawbacks of the prior art by providing a shoulder hanging type and backpack type grass trimmer folding device capable of being folded and unfolded easily, reducing volume, and facilitating storage and transportation.

To achieve the aforementioned objective, the present invention provides a shoulder hanging type and backpack type grass trimmer having a joint installed at the middle of the main body for positioning the handle. The joint comprises: a lower casing; a fixed base having an upper casing at a lower end of the fixed base and corresponding to the lower casing to fix the main body, with the upper end having a containing slot for containing and axially coupling the handle, and having a stop member installed at the middle of the front end of the containing slot; and a positioning element for unfolding the handle to transversally position at the fixed base, or folding the handle to longitudinally position at both sides of the main body; to achieve the effects of folding or unfolding the grass trimmer, reducing the volume, and facilitating the storage and transportation of the grass trimmer.

### BRIEF DESCRIPTION OF THE DRAWINGS

FIG. 1 is a perspective view of a conventional shoulder hanging type and backpack type grass trimmer;

FIG. 2 is a perspective view of a first preferred embodiment of the present invention;

FIG. 3 is a schematic blowup view of Part A of FIG. 2;

FIG. 4 is a cross-sectional blowup view of Part A of FIG. 2;

FIG. 5 is a perspective view of a folded status of the first preferred embodiment of the present invention;

FIG. 6 is a schematic view of a folded status of the first preferred embodiment of the present invention;

FIG. 7 is a perspective view of a folded status of a second preferred embodiment of the present invention;

FIG. 8 is a perspective view of a third preferred embodiment of the present invention;

FIG. 9 is a schematic blowup view of Part B of FIG. 8;

FIG. 10 is a cross-sectional blowup view of Part B of FIG. 8;

FIG. 11 is a perspective view of a folded status of the third preferred embodiment of the present invention; and

FIG. 12 is a cross-sectional view of a folded status of the third preferred embodiment of the present invention.

### DETAILED DESCRIPTION OF THE PREFERRED EMBODIMENTS

The objectives, technical characteristics, measures, effects and advantages of the present invention will become apparent with the detailed description of preferred embodiments accompanied with the illustration of related drawings as follows.

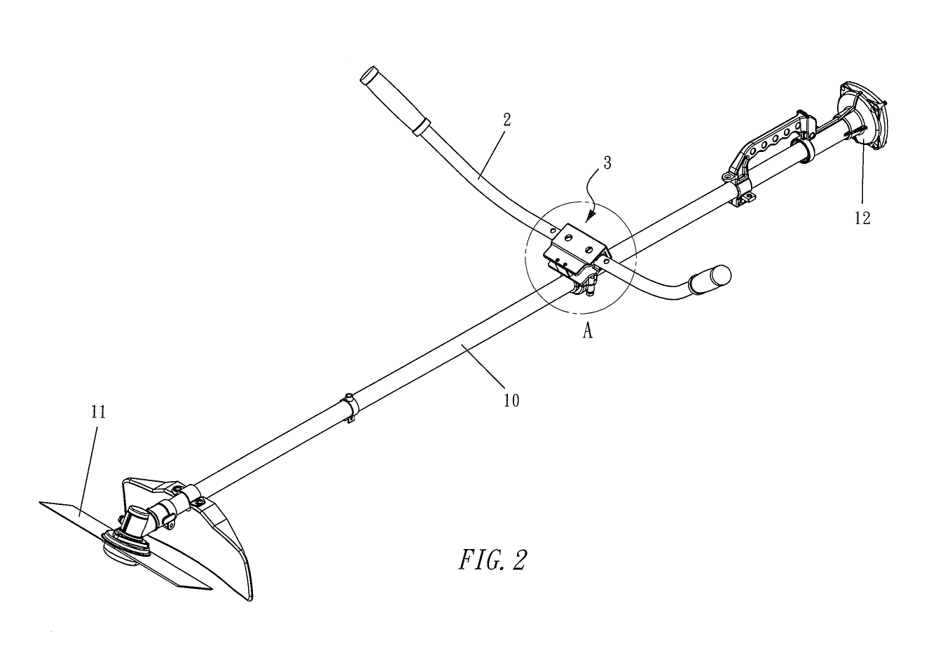

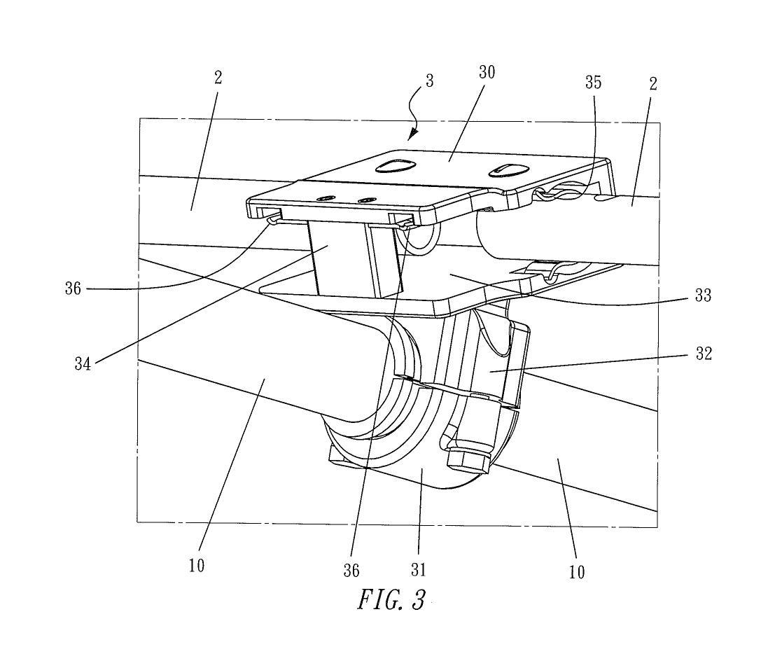

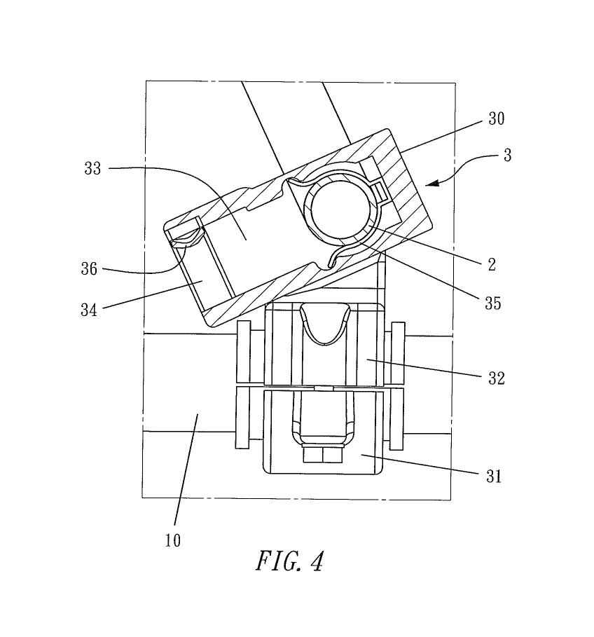

With reference to FIGS. 2 to 4, the present invention relates to a shoulder hanging type and backpack type grass trimmer. The shoulder hanging type and backpack type grass trimmer has a main body 10, a cutter 11 and an engine 12, which are prior art and thus will not be described. The present invention is characterized in that a joint 3 is installed at the middle of the main body 10 for positioning a handle 2. The joint 3 comprises a lower casing 31. A fixed base 30 has an upper casing 32 disposed at a lower end of the fixed base 30 and at an upper position with respect to the lower casing 31 for fixing to the main body 10. The upper end of the fixed base 30 has a containing slot 33 tilted forward and downwardly for containing and axially coupling the handle 2, with the handle 2 rotatable to an angle (greater than 90 degrees). The fixed base 30 is situated at the middle of the front end of the containing slot 33. A stop member 34 limits the rotating angle of the handle 2. A positioning element includes first and second positioning elements 35, 36 installed on both sides of the rear end of the containing slot 33 and both sides of the stop member 34 respectively for positioning the handle 2. The first positioning element 35 is a hose clamp, and the second positioning element 36 is an elastic clamping plate.

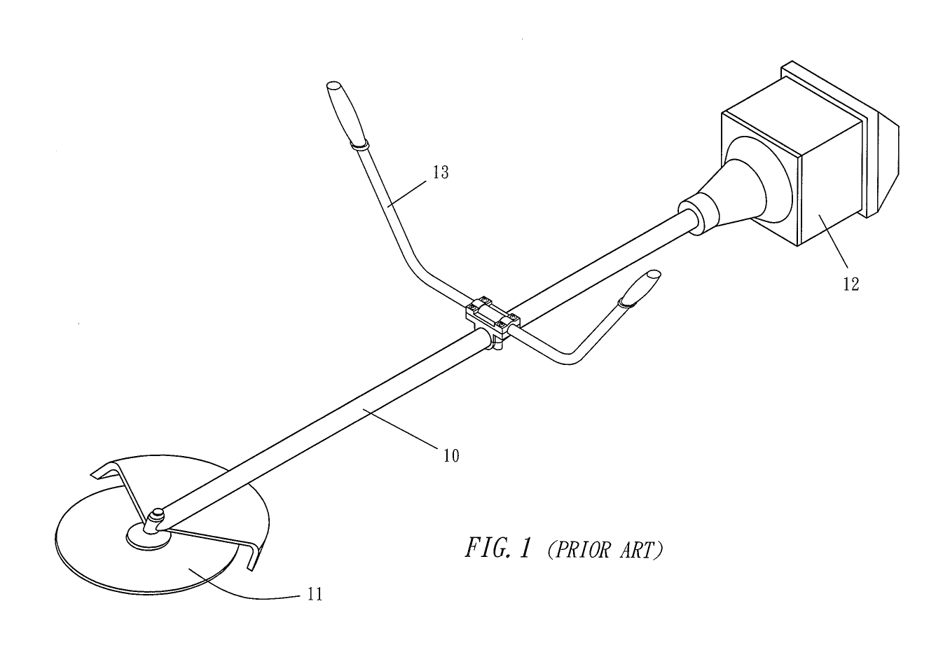

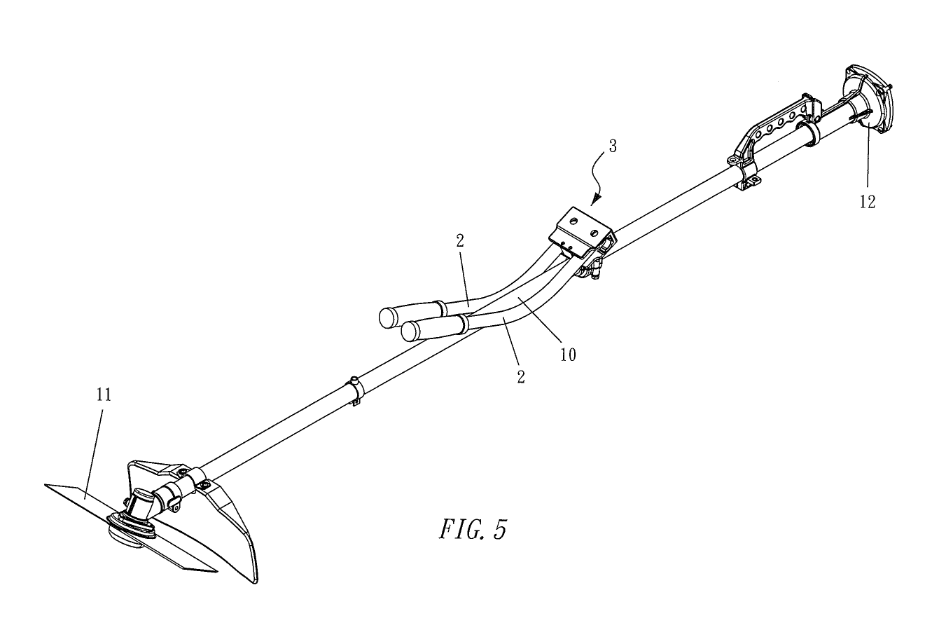

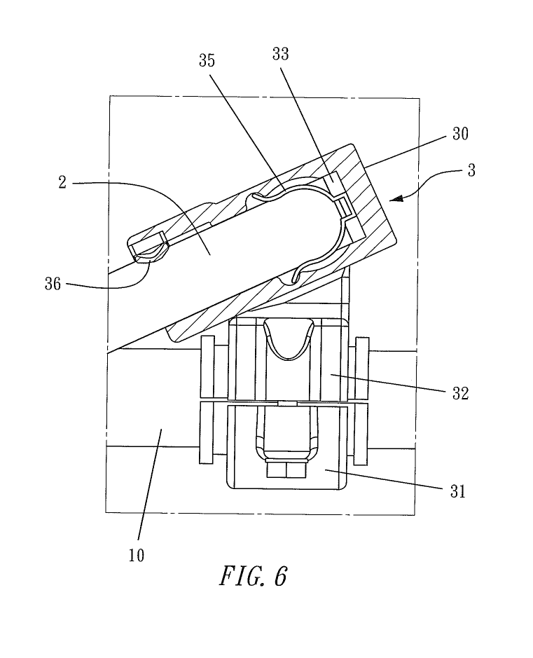

When the structure is unfolded, an inner end of the handle 2 is clamped and fixed with the first positioning element 35 (which is the hose clamp) and transversally attached to a rear end of the fixed base 30 (or the containing slot 33) as shown in FIGS. 1 and 2 to operate and use the grass trimmer. If it is necessary to fold the grass trimmer, users simply apply a force to rotate the handle 2 forward to an angle in order to separate the first positioning element 35, and then clamp and fix to the second positioning element 36 (or the elastic clamping plate) and longitudinally attach onto the stop member 34 and both sides of the main body 10 as shown in FIGS. 5 and 6 to complete folding the handle 2. If it is necessary to unfold the grass trimmer, the handle 2 is rotated backward to an angle to separate the second positioning element 36 and then clamp to the first positioning element 35 to transversally attach the handle 2 at the rear end of the fixed base 30 (or the containing slot 33) to resume the unfolded status as shown in FIGS. 1 and 2.

In summation, the present invention has the following advantages and effects and improves over the prior art.
1. The handle 2 can be unfolded or folded easily to provide a convenient operation.
2. Since the fixed base of the containing slot 33 is tilted forward and downward, and therefore when the handle 2 is folded, the handle 2 can be longitudinally attached and fixed onto both sides of the main body 10. Such arrangement not only reduces the volume to facilitate storage and transportation, but also prevent users from tripping.

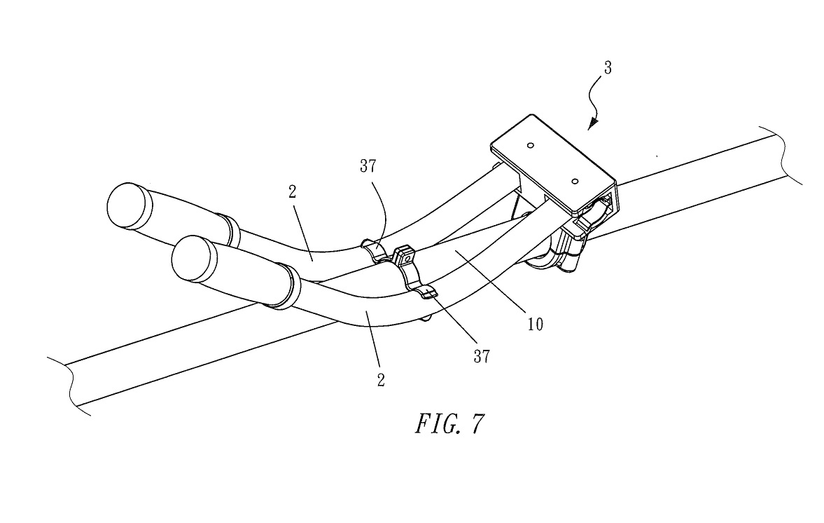

With reference to FIG. 7 for the second preferred embodiment of the present invention, the second positioning element 37 is installed at an appropriate position of the main body 10. Thus, when the grass trimmer is folded, the handle 2 is clamped, fixed and longitudinally attached onto both sides of the main body 10 to achieve the same effect as the first preferred embodiment.

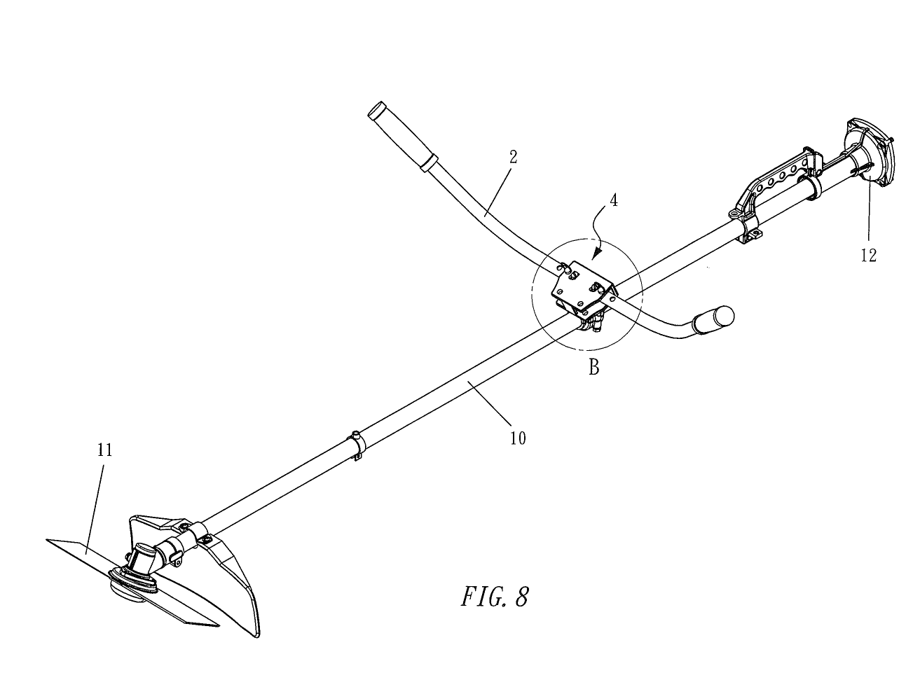

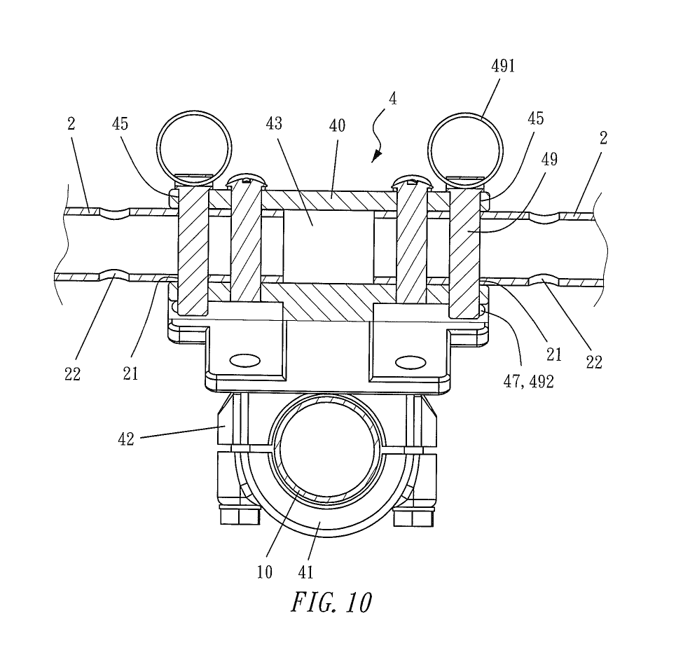

With reference to FIGS. 8 to 10 for the third preferred embodiment of the present invention, the joint 4 also comprises a fixed base 40, a lower casing 41 and a positioning element 49. The fixed base 40 has an upper casing 42 disposed at a lower end of the fixed base 40 and corresponding to the lower casing 41 to fix to the main body 10. The upper end also has a tilted containing slot 43 for containing and axially coupling the handle 2, and a stop member 44 installed at the front end of the containing slot 43. These elements are the same as those of the first preferred embodiment, except that the first and second through holes 21, 22 are formed at inner ends of the handle 2. The front and back ends of both outer sides of the fixed base 40 have first and second penetrating holes 45, 46 formed at up and down positions with respect to each other. The bottom of the fixed base 40 is disposed under the penetrating holes 45, 46 and has a latch hole 47 for inserting and positioning the positioning element 49. The positioning element 49 is an elastic latch which is mainly a rod with a pull ring 491 installed at an upper end of the positioning element 49, and an elastic latch member 492 (such as a steel ball) installed at a lower end of the positioning element 49.

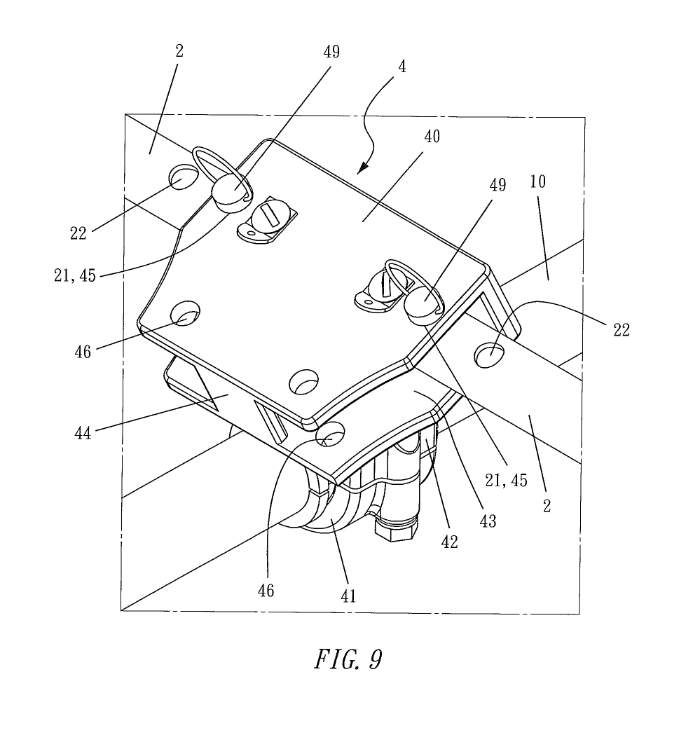

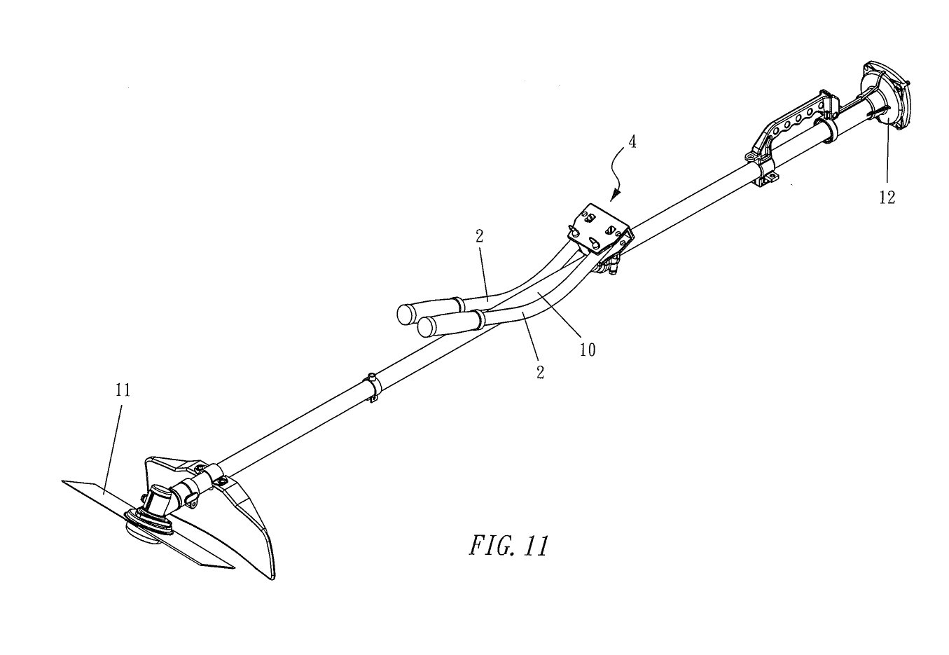

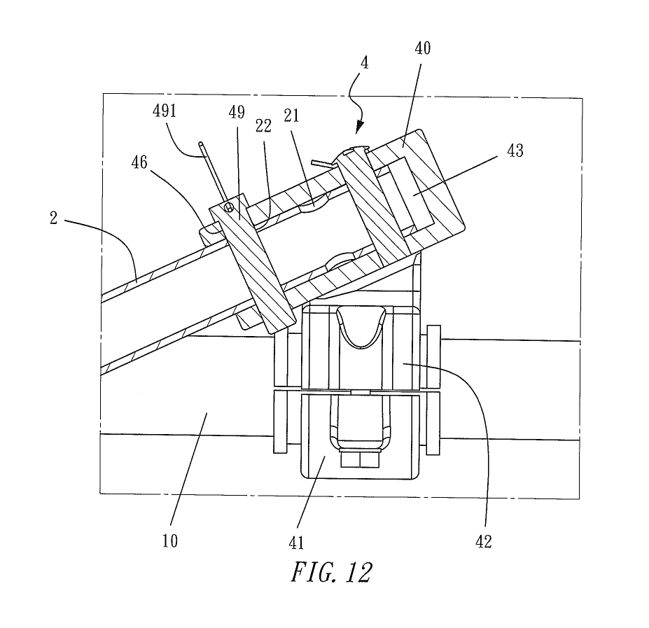

When the structure is unfolded, the positioning element 49 (or the elastic latch) is inserted into the first penetrating hole 45 of the fixed base and the first through hole 21 of the handle and latched to the latch hole 47. Thus, the handle 2 is transversally attached and fixed at a rear end of the fixed base 40 (containing slot 43) as shown in FIGS. 8 and 9 for operating and using the grass trimmer. If it is necessary to fold the grass trimmer, users simply need to pull the pull ring 491 of the positioning element 49 to separate the handle 2 and the fixed base 40, and then turn the handle 2 forward to an angle to align the second through hole 22 of the handle precisely with the second penetrating hole 46 of the fixed base, and then insert and latch the positioning element 49 to longitudinally attach the handle 2 to the stop member 44 and both sides of the main body 10 as shown in FIGS. 11 and 12 to complete folding the handle 2. If it is necessary to unfold the grass trimmer, the users pull the positioning element 49 to separate the handle 2 and the fixed base 40, and then turn the handle 2 to an angle to align the first through hole 21 of the handle precisely with the first penetrating hole 45 of the fixed base, and then insert and position the positioning element 49 to transversally attach the handle 2 to the rear end of the fixed base 40 to resume the unfolded status as shown in FIGS. 8 and 9 and achieve the same effects as the preferred embodiment.

In view of the aforementioned three preferred embodiments, the joint 3, 4 of the present invention comprises a fixed base 30, 40, for fixing the main body 10 at a lower part and axially coupling the handle 2 at an upper part, and the positioning elements 35, 36, 49 (such as the hose clamp and the elastic latch) are provided for when the handle 2 is unfolded, the handle 2 is transversally positioned at the fixed base 30, 40, or longitudinally positioned on both sides of the main body 10 to achieve the effects of unfolding and folding the grass trimmer, and reducing the volume to facilitate storage and transportation.

In summation of the description above, the present invention achieves the expected objectives and effects. While the invention has been described by means of specific embodiments, numerous modifications and variations could be made thereto by those skilled in the art without departing from the scope and spirit of the invention set forth in the claims.

What is claimed is:

1. A grass trimmer comprising:
a cutter;
an engine;
a main body extending between the cutter and the engine;
first and second handles each having an inner end; and
a joint installed at a middle of the main body, with the joint comprising:
a lower casing;
a fixed base having an upper casing at a lower end of the fixed base and corresponding to the lower casing, with the upper and lower casings fixed to the middle of the main body, with the inner ends of the first and second handles pivotably connected to the fixed base about first and second pivot axes located on opposite sides of the main body, with an upper end of the fixed base having a containing slot for containing and axially coupling each handle, with a stop member installed at a middle of a front end of the containing slot; and
a positioning element removably attaching to the first and second handles, with each handle folding between an unfolded position transversally positioned relative to the main body and a folded position longitudinally positioned relative to the main body to achieve folding or unfolding the grass trimmer.

2. The grass trimmer of claim 1, wherein the fixed base containing slot faces forward towards the cutter and is tilted downward toward the main body.

3. The grass trimmer of claim 1, wherein the positioning element includes first positioning elements installed on both sides at a rear end of the containing slot of the fixed base attaching the handles in the unfolded position and includes second positioning elements installed at both sides of the stop member respectively attaching the handles in the folded position.

4. The grass trimmer of claim 3, wherein the first positioning element is a hose clamp.

5. The grass trimmer of claim 3, wherein the second positioning element is installed at the main body.

6. The grass trimmer of claim 3, wherein the second positioning element is an elastic clamping plate.

7. The grass trimmer of claim 1, wherein each handle includes first and second through holes formed on inner ends of the handle respectively, with first and second penetrating holes formed at a top and a bottom of both sides of the fixed base and corresponding to the first and second through holes of the handle respectively, and wherein the positioning element comprises first and second positioning elements selectively and respectively inserted into the first and second through holes of the handle and the first and second penetrating holes of the fixed base to fix the first and second handles in position.

8. The grass trimmer of claim 7, wherein the bottom of the fixed base is disposed under the penetrating hole and has a latch hole for positioning the positioning element.

9. The grass trimmer of claim 7, wherein each positioning element comprises a pull ring installed at an upper end and an elastic latch member installed at a lower end.

10. The grass trimmer of claim 7, wherein each of the first and second handles have an outer end opposite to the inner end, with the outer end located intermediate the first and second pivot axes and the cutter in the folded position.

11. The grass trimmer of claim 1, wherein the positioning element includes first positioning elements installed on both sides at a rear end of the containing slot of the fixed base attaching the handles in the unfolded position and includes second positioning elements installed at both sides of the stop member respectively attaching the handles in the folded position, wherein the fixed base containing slot faces forward towards the cutter and is tilted downward toward the main body.

12. The grass trimmer of claim 9, wherein each of the first and second handles have an outer end opposite to the inner end, with the outer end located intermediate the first and second pivot axes and the cutter in the folded position.
